(19) United States
(12) Patent Application Publication
(10) Pub. No.: US 2014/0290133 A1
(43) Pub. Date: Oct. 2, 2014

(54) SEED MAT

(71) Applicant: Kathie Lynn Seacord, Commerce Township, MI (US)

(72) Inventor: Kathie Lynn Seacord, Commerce Township, MI (US)

(73) Assignee: Seamates, LLC, Commerce Twp., MI (US)

(21) Appl. No.: 14/227,788

(22) Filed: Mar. 27, 2014

Related U.S. Application Data
(60) Provisional application No. 61/806,718, filed on Mar. 29, 2013.

(51) Int. Cl. A01C 1/04

(52) U.S. Cl. CPC A01C 1/044
USPC 47/56

(57) ABSTRACT

A seed mat for placement on a growing medium, such as soil. The seed mat includes a biodegradable mat having at least one hole, and a seed that is placed in the hole. The seed is encapsulated in the hole between top and bottom biodegradable sheets that are adhered to the top and bottom surfaces of the mat. An adhesive is used to adhere the top and bottom sheets to the mat. The adhesive can optionally include a water-soluble fertilizer

### CROSS REFERENCE TO RELATED APPLICATION

This application claims the benefit of U.S. Provisional Application 61/806,718, which was filed on Mar. 29, 2013, the disclosure of which is hereby incorporated by reference.

### BACKGROUND OF THE INVENTION

1. Field of the Invention

The present invention pertains to a mat for positioning seeds on a growing medium. More particularly, the present invention pertains to a biodegradable mat for positioning seeds on a growing medium.

2. Description of the Prior Art

The conventional method of planting seeds in a garden or elsewhere is to specifically place each seed in its desired location and cover the seed with a growing medium, which is typically soil. However, there are ergonomic problems associated with this, especially for elderly people or those who are disabled. Planting seeds in this matter requires the user to usually kneel on the ground. In addition, it can be difficult to accurately remember where each seed is located once it has been buried in the soil.

But even more so, there is difficulty in planting very small seeds which can be difficult to see and handle. Thus, there remains a need for a device and method that makes it easier to position seeds on the growing medium.

The present invention, as is detailed hereinbelow, seeks to address this problem by providing a biodegradable mat having at least one hole for receiving a seed, and biodegradable top and bottom sheets that are adhered to the mat and encapsulate the seed in the hole.

### SUMMARY OF THE INVENTION

The present invention provides a seed mat for placement on a growing medium comprising:

(a) a biodegradable mat having a top surface and a bottom surface, and including at least one hole, the hole being centered within an indentation;

(b) a seed positioned in the hole;

(c) a bottom biodegradable sheet adhered to the bottom surface of the mat; and

(d) a top biodegradable sheet adhered to the top surface; whereby the bottom sheet and the top sheet encapsulate the seed within the hole in the mat.

Optionally, the mat comprises railroad board, and the top sheet and the bottom sheet are tissue paper.

Optionally, and preferably, the diameter of the hole on the bottom surface of the mat is less than the diameter of the hole on the top surface of the mat.

In another aspect hereof, there is provided a method of manufacturing a seed mat including the steps of:

(a) providing a biodegradable sheet of railroad board, at least one seed, and two sheets of biodegradable tissue paper;

(b) penetrating through the railroad board to make at least one hole in the railroad board;

(c) adhering one of the sheets of tissue paper to a bottom surface of the railroad board by wetting the sheet of tissue paper and placing the sheet of tissue paper against the bottom surface of the railroad board;

(d) placing one of the seeds in each provided hole; and

(e) adhering the other sheet of tissue paper to a top surface of the railroad board by wetting the other sheet of tissue paper and placing the other sheet against the top surface of the railroad board.

Optionally, the hole is made in the railroad board by drilling or punching an object through the railroad board. Optionally, and preferably, this method also includes the step of creating an indentation around each hole.

In another embodiment hereof, there is provided:

(a) a biodegradable mat having a top surface, a bottom surface, and including at least one hole;

(b) a seed positioned in the hole;

(c) a top biodegradable sheet and a bottom biodegradable sheet, the top biodegradable sheet adhered to the top surface of the mat, and the bottom biodegradable sheet adhered to the bottom surface of the mat; and

(d) an adhesive comprising water and a water-soluble fertilizer, the adhesive being positioned between the top sheet and the mat, and also between the bottom sheet and the mat to adhere the top sheet and the bottom sheet to the mat;

(e) whereby the bottom sheet and the top sheet encapsulate the seed within the hole in the mat.

In yet another embodiment hereof, there is provided:

(a) a greeting card;

(a) a biodegradable mat having a top surface, a bottom surface, and including at least one hole, the biodegradable mat being connected to the greeting card;

(b) a seed positioned in the hole; and

(c) a top biodegradable sheet and a bottom biodegradable sheet, the top biodegradable sheet adhered to the top surface of the mat, and the bottom biodegradable sheet adhered to the bottom surface of the mat;

(d) whereby the bottom sheet and the top sheet encapsulate the seed within the hole in the mat.

Optionally, the biodegradable mat is in the form of a predefined shape, such as a heart, a cross, letters, numbers, and so forth.

Optionally, the biodegradable mat is releasably connected to the greeting card, such as by being perforated.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a top perspective view of a first embodiment of the present invention hereof;

FIG. 2 is an enlarged cross-sectional view of the seed mat;

FIG. 3 is a cross-sectional view showing the diameter of the hole at the top surface being wider than the diameter a hole at the bottom surface of the mat; and

FIG. 4 is an embodiment of the invention including a greeting card having the seed mat releasably attached thereto.

### DETAILED DESCRIPTION OF THE INVENTION

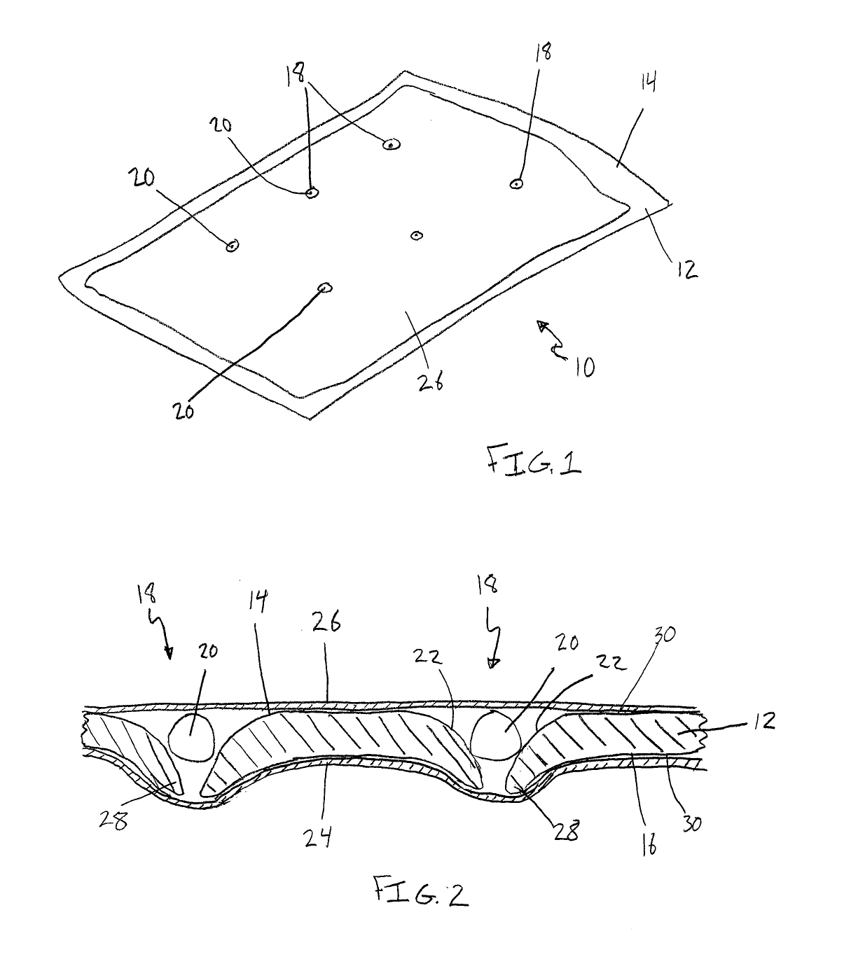

In accordance with the present invention, and as shown generally in FIG. 1, and cross-sectionally in FIG. 2, there is provided a seed mat 10 for placement on a growing medium comprising: (a) a biodegradable mat 12 having a top surface 14 and a bottom surface 16, and including at least one hole 18 for receiving a seed 20, the hole 18 being centered within an indentation 22; (b) a bottom biodegradable sheet 24 adhered to the bottom surface 16 of the mat 12; (c) a top biodegradable sheet 26 adherable to the top surface 14; whereby the bottom sheet 24 and the top sheet 26 encapsulate the seed 20 within the hole 18 in the mat 12.

The biodegradable mat 12 is a flat sheet of biodegradable material that can be any desirable shape, such as square, rectangular, circular, and so forth. The mat 12 is formed from any suitable biodegradable material, but preferably it is formed from a cellulosic material such as paper, railroad board (also known as Bristol board or Bristol paper), cardboard, or the like. Although it is preferable that the mat 12 has some degree of flexibility to it, it is preferable that it have sufficient mass to absorb water. Preferably the mat 12 is formed from a cellulosic material having a pound weight of about 50 pounds to about 110 pounds. As understood by those having ordinary skill in the art, “pound weight” is a standardized measurement of a sheet of material, and in particular, it refers to the weight of 500 sheets of 20″×26″ paper. For example, typical copy paper is usually about 20 pounds.

It is also preferable that the mat 12 is absorbent. In this regard, the mat 12 soaks in water and helps maintain a relatively constant, stable, and desirable level of moistness for the seed 20. This environment, which is neither dry nor overly wet, will dramatically increase the rate of seed germination.

The mat 12 has a top surface 14 and a bottom surface 16, and at least one hole 18 for receiving a seed 20. In one embodiment, the hole 18 is centered within a downward indentation 22. The hole 18 can be created by drilling downward through a stack of mats, such as by using a drill bit. The hole 18 can also be created using any other suitable method, such as by punching the hole 18 through a stack of mats using an object like a punch die. The indentation 22 is formed when the hole 18 is created and the material surrounding the hole 18 is pressed downward. A lip 28 may also be formed on the bottom surface 16 around the hole 18.

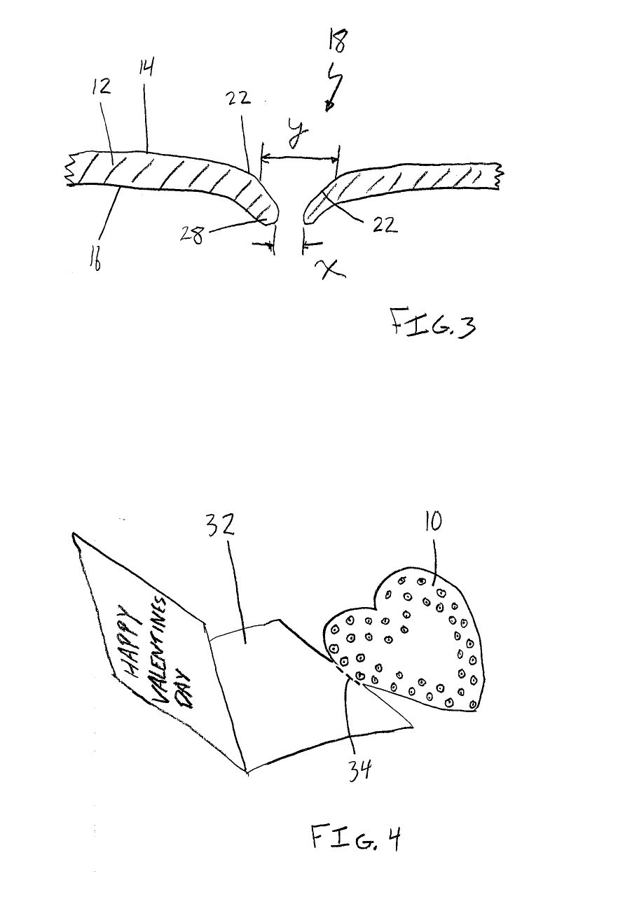

Preferably, and as shown in FIG. 3, the diameter x of the hole 18 on the bottom surface 16 of the mat 12 is less than the diameter y of the hole 18 on the top surface 14 of the mat 12. The indentation 22 surrounding the hole 18 works together with the hole 18 having a smaller diameter at the bottom surface 16 to help “catch” and position a seed 20 within each hole 18.

In addition, there is provided a top sheet 26 and a bottom sheet 24 that are adhered to the top and bottom surfaces 14,16 of the mat 12, respectively. The top and bottom sheets 24,26 are also preferably biodegradable. The top and bottom sheets 24,26 are preferably formed from a lightweight cellulosic material, such as tissue paper. When the seed 20 is positioned in the hole 18 of the mat 12 and the top sheet 26 and bottom sheet 24 are adhered to the respective surfaces of the mat 12, the seed 20 is encapsulated within the hole 18.

The top and bottom sheets 24,26 are adhered to the respective top and bottom surfaces 14,16 of the mat 12 with an adhesive 30. The adhesive 30 can be water that is misted on the sheets 24,26. The wetted, or misted sheets 24,26 are then placed against the respective surface of the mat 12. The wetted sheets 24,26 will remain adhered to the mat 12 after they have dried.

According to another aspect hereof, the adhesive 30 can comprise a water-soluble fertilizer that is dissolved into the water of the adhesive 30. Any suitable type of water-soluble fertilizer can be used herewith, but preferably the fertilizer is an all-purpose plant food, such as the “Water Soluble All Purpose Plant Food 24-8-16” sold under the trademark Miracle-Gro®. It is understood by those having ordinary skill in the art that the numbers “24-8-16” represent the percentage of nitrogen, phosphate, and potash, respectively. It is also to be understood that varying mixtures of nitrogen, phosphate, and potash can be used herewith.

The mat 12 can include any number of holes 18. For example, the mat 12 can be as small as 1 inch wide and include only a single hole 18 and seed 20. In this application, the user is able to easily place the single seed 20 wherever he or she wishes. On the other end of the spectrum, the mat 12 can be very large in size—even so large that it can cover an entire garden. In this application, the mat 12 can include the seeds 20 from a variety of different flowers, vegetables, etc. The holes 18 and seeds 20 in the mat 12 are pre-positioned in any suitable type of arrangement.

For example, if the seeds 20 are for a variety of different vegetables in a vegetable garden, then the holes 18 and the seeds 20 can be properly spaced from each other as required for each type of plant. In another example, the seeds 20 can be for different flowers and pre-positioned for a pre-arranged flower bed or to create a specific design (for example, in the shape of a heart). It is to be understood that any suitable type of seed 20 can be used herewith.

The mat 12 can also include an arrangement of seeds 20 that should be planted at the same time in the growing calendar. Thus, various mats can be placed in the garden at pre-specified times depending upon the hardiness zone and the requirements of the seeds 20. Therefore, a kit can be sold which has multiple mats, and each mat 12 should be placed in the garden at a specified time as required by the seeds 20 on that particular mat 12.

It is intended that the seed mat 10 can be provided either with or without the seeds 20 in place. If the seed mat 10 is sold to the user with the seeds 20 in place, then the user simply places the seed mat 10 in the desired location on the soil and waters the seeds 20. The mat 12 and the top and bottom sheets 24,26 retain moisture, thereby helping the seeds 20 to germinate. The top and bottom sheets 24,26 biodegrade relatively quickly—within a matter of days or weeks, and the mat 12 will also biodegrade after that. The mat 12 may also help reduce evaporation of water out of the soil, thereby helping provide the seedling with sufficient moisture.

In another aspect hereof, there is provided a method of manufacturing a seed mat 10 including the steps of: (a) providing the biodegradable sheet of railroad board 12, at least one seed 20, and two sheets of biodegradable tissue paper 24,26; (b) making at least one hole 18 in the railroad board 12 by penetrating an object through the railroad board 12; (c) adhering one of the sheets of tissue paper to a bottom surface 16 of the railroad board 12 by wetting the sheet and placing the sheet against the bottom surface 16 of railroad board 12; (d) placing one of these seeds 20 in each provided hole 18; and (e) adhering to the other sheet of tissue paper to a top surface 14 of the railroad board 12 by wetting the other sheet and placing the other sheet against the top surface 14 of the railroad board 12.

Optionally, this method can also include the steps of drilling or punching an object through the railroad board 12 to make the hole 18. Optionally, and preferably, this method also includes the step of creating an indentation 22 around each hole 18.

In yet another embodiment of the invention, and as shown in FIG. 4, there is provided a greeting card 32 having the seed mat 10 attached thereto. The seed mat 10 is releasably connected to the greeting card 32, such as by a perforation 34. Preferably, the seed mat 10 is formed from the same sheet of material as the greeting card 32. Optionally, the biodegradable mat 12 is in the form of a predefined shape, such as a heart, a cross, letters, numbers, and so forth. In this manner, the type of greeting card 32 is intended to correspond to the shape of the seed mat 10. For example, a bereavement card can have a seed mat 10 in the shape of a cross or the Star of David. Likewise, a birthday card could have a seed mat 10 in the shape of a number corresponding to the recipient's age, or a Valentine's Day card could be in the shape of a heart (as shown in FIG. 4).

According to the invention described above, there is provided a biodegradable mat having at least one hole for receiving a seed, and biodegradable top and bottom sheets that are adhered to the mat and encapsulate the seed in the hole.

What is claimed is:

1. A seed mat for placement on a growing medium comprising:
a biodegradable mat having a top surface and a bottom surface, and including at least one hole, the hole being centered within an indentation;
a seed positioned in the hole;
a bottom biodegradable sheet adhered to the bottom surface of the mat; and
a top biodegradable sheet adhered to the top surface;
whereby the bottom sheet and the top sheet encapsulate the seed within the hole in the mat.

2. The seed mat of claim 1 in which the mat is formed from railroad board, and the top and bottom biodegradable sheets are formed from tissue paper.

3. The seed mat of claim 2 including an adhesive for adhering the top and bottom biodegradable sheets to the mat, the adhesive having a water-soluble fertilizer

4. The seed mat of claim 3, wherein the hole has a larger diameter at the top surface of the mat than the diameter of the hole at the bottom surface of the mat.

5. The seed mat of claim 1 including an adhesive for adhering the top and bottom biodegradable sheets to the mat, the adhesive having a water-soluble fertilizer

6. The seed mat of claim 5, wherein the hole has a larger diameter at the top surface of the mat than the diameter of the hole at the bottom surface of the mat.

7. The seed mat of claim 1, wherein the hole has a larger diameter at the top surface of the mat than the diameter of the hole at the bottom surface of the mat.

8. A seed mat comprising:
a biodegradable mat having a top surface, a bottom surface, and including at least one hole;
a seed positioned in the hole;
a top biodegradable sheet and a bottom biodegradable sheet, the top biodegradable sheet adhered to the top surface of the mat, and the bottom biodegradable sheet adhered to the bottom surface of the mat; and
an adhesive comprising water and a water-soluble fertilizer, the adhesive being positioned between the top sheet and the mat, and also between the bottom sheet and the mat to adhere the top sheet and the bottom sheet to the mat;
whereby the bottom sheet and the top sheet encapsulate the seed within the hole in the mat.

9. The seed mat of claim 8 in which the mat is formed from railroad board, and the top and bottom biodegradable sheets are formed from tissue paper.

10. The seed mat of claim 9, wherein the hole has a larger diameter at the top surface of the mat than the diameter of the hole at the bottom surface of the mat.

11. The seed mat of claim 8, wherein the hole has a larger diameter at the top surface of the mat than the diameter of the hole at the bottom surface of the mat.

12. An article of manufacture comprising:
a greeting card;
a biodegradable mat having a top surface, a bottom surface, and including at least one hole, the biodegradable mat being connected to the greeting card;
a seed positioned in the hole; and
a top biodegradable sheet and a bottom biodegradable sheet, the top biodegradable sheet adhered to the top surface of the mat, and the bottom biodegradable sheet adhered to the bottom surface of the mat;
whereby the bottom sheet and the top sheet encapsulate the seed within the hole in the mat.

13. The article of manufacture of claim 12 in which the mat and the greeting card are formed from railroad board, and the top and bottom biodegradable sheets are formed from tissue paper.

14. The article of manufacture of claim 13 including an adhesive for adhering the top and bottom biodegradable sheets to the mat, the adhesive having a water-soluble fertilizer

15. The article of manufacture of claim 14, wherein the hole has a larger diameter at the top surface of the mat than the diameter of the hole at the bottom surface of the mat.

16. The article of manufacture of claim 12 including an adhesive for adhering the top and bottom biodegradable sheets to the mat, the adhesive having a water-soluble fertilizer

17. The article of manufacture of claim 16, wherein the hole has a larger diameter at the top surface of the mat than the diameter of the hole at the bottom surface of the mat.

18. The article of manufacture of claim 1, wherein the hole has a larger diameter at the top surface of the mat than the diameter of the hole at the bottom surface of the mat.

19. The article of manufacturer of claim 12 including a perforation between the greeting card and the mat which facilitates in removing the mat from the greeting card.

20. The article of manufacturer of claim 13 including a perforation between the greeting card and the mat which facilitates in removing the mat from the greeting card.
